(19) United States
(12) Patent Application Publication
(10) Pub. No.: US 2026/0252246 A1
(43) Pub. Date: Aug. 27, 2026

(54) MEMORY DEVICE AND DATA ACCESSING METHOD

(71) Applicant: REALTEK SEMICONDUCTOR CORPORATION, HSINCHU (TW)

(72) Inventors: YI-FAN CHIEN, HSINCHU (TW); TUNG-MIN LIN, HSINCHU (TW)

(21) Appl. No.: 19/464,981

(22) Filed: Jan. 30, 2026

(30) Foreign Application Priority Data
Feb. 21, 2025 (TW) 114106614

(51) Int. Cl. G06F 3/06

(52) U.S. Cl. CPC G06F 3/0631; G06F 3/061; G06F 3/0658; G06F 3/0673

(57) ABSTRACT

A memory device includes a memory and a memory controller circuit. The memory controller circuit is configured to, according to a memory depth of the memory, divide the memory into a plurality of storage spaces, divide first data into a plurality of first subdata, and respectively store the plurality of first subdata into the plurality of storage spaces.

### BACKGROUND OF THE INVENTION

### 1. Field of the Invention

The present disclosure relates to a memory device, and more particularly to a memory able to increase an amount of data processed within a single period, and a data accessing method thereof.

### 2. Description of Related Art

In some related approaches, a memory device writes data into a memory according to continuous physical addresses, in which the memory can only be accessed by a single device at a single time. If devices simultaneously access the memory, the devices need to wait in queue to access the memory in turn. Thus, most devices will be in an idle state without data to process, resulting in reduced overall performance.

### SUMMARY OF THE INVENTION

In some aspects, an object of the present disclosure is, but not limited to, providing a memory device that is configured to increase an amount of data processed within a single period, and a data accessing method thereof, so as to improve deficiencies of the prior art.

In some aspects, a memory device includes a memory and a memory controller circuit. The memory controller circuit is configured to, according to a memory depth of the memory, divide the memory into a plurality of storage spaces, divide first data into a plurality of first subdata, and respectively store the plurality of first subdata into the plurality of storage spaces.

In some aspects, a data accessing method, performed by a memory controller circuit, includes the following operations: dividing a memory into a plurality of storage spaces according to a memory depth of the memory; dividing first data into a plurality of first subdata; and respectively storing the plurality of first subdata into the plurality of storage spaces.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 is a schematic diagram of a memory device according to some embodiments of the present disclosure.

FIG. 2 is a schematic diagram showing operations of the memory controller circuit in FIG. 1 configuring storage spaces of the memory according to some embodiments of the present disclosure.

FIG. 3 is a schematic diagram showing operations of the master devices accessing the memory device according to some embodiments of the present disclosure.

FIG. 4 is a flowchart of a data accessing method according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuit” may indicate an object, which is formed with one or more transistors and/or one or more active/passive elements according to a specific arrangement, for processing signals.

As used herein, the term "and/or" includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, similar/identical elements in various figures are designated with the same reference number.

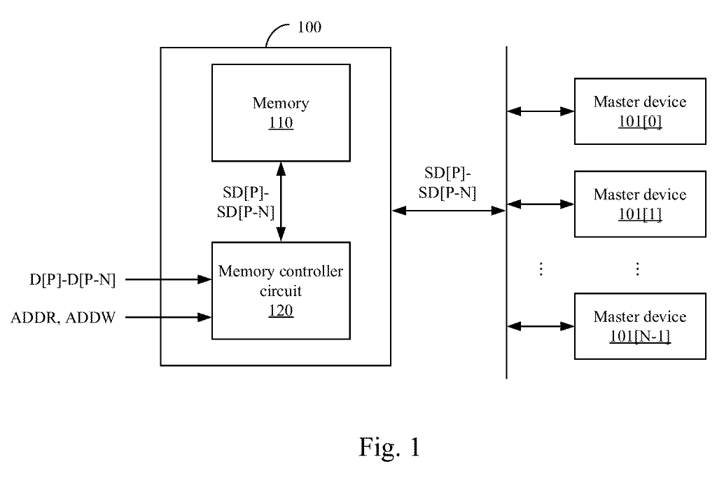

FIG. 1 is a schematic diagram of a memory device 100 according to some embodiments of the present disclosure. The memory device 100 may be coupled to master devices 101[0] to 101[N-1], and may simultaneously provide data to the master devices 101[0] to 101[N-1].

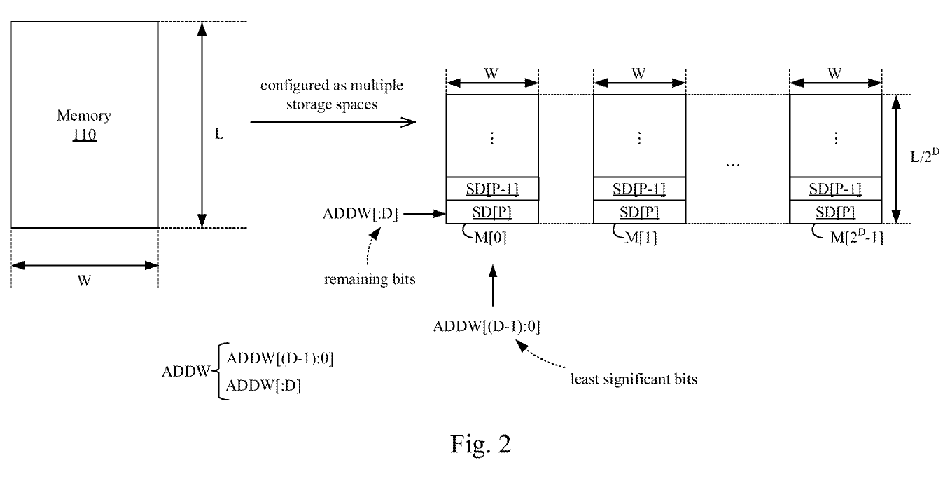

The memory device 100 includes a memory 110 and a memory controller circuit 120. In some embodiments, the memory 110 may be, but is not limited to, a static random-access memory having a single port. The memory 110 may store multiple subdata SD[P] to SD[P-N], in which the multiple subdata SD[P] correspond to data D[P] (that is, the multiple subdata SD[P] may be combined into one data D[P]), and the subdata SD[P-1] correspond to data D[P-1]. By analogy, the multiple subdata SD[P-N] correspond to data D[P-N]. In some embodiments, each of data D[P] to data D[P-N] may be network packets; however, the present disclosure is not limited thereto. In some embodiments, data D[P] to data D[P-N] may be data having time dependency or temporal continuity; however, the present disclosure is not limited thereto. In some embodiments, the memory controller circuit 120 may be implemented with a microcontroller circuit and/or a digital circuit having data management capability; however, the present disclosure is not limited thereto. The memory controller circuit 120 may, according to a memory depth of the memory 110, divide the memory 110 into storage spaces (the storage spaces M[0] to M[2^{D}-1] shown in FIG. 2), and divide data D[P] into the multiple subdata SD[P], thereby respectively storing the multiple subdata SD[P] into the storage spaces M[0] to M[2^{D} -1]. The arrangement will be described later with reference to FIG. 2.

In some embodiments, the memory controller circuit 120 may store data D[P], data D[P-1] or data D[P-N] mentioned above into corresponding locations in the memory 110 according to an address signal ADD. Similarly, in some embodiments, the memory controller circuit 120 may read the multiple subdata SD[P] to SD[P-N] mentioned above from the corresponding locations in the memory 110 according to an address signal ADDR, and sequentially provide the read subdata to other devices, for example, the master devices 101[0] to 101[N-1]. In some embodiments, the address signal ADDW and/or the address signal ADDR may be issued by a central processing unit (not shown) or a direct memory access controller (not shown) in the system. In some embodiments, the memory controller circuit 120 may decode a data write request (not shown) issued by other devices, for example, the master devices 101[0] to 101[N-1], to obtain the address signal ADDW. In some embodiments, the memory controller circuit 120 may decode a data read request (not shown) issued by other devices, for example, the master devices 101[0] to 101[N-1], to obtain the address signal ADDR. In some embodiments, the address signal ADDR and the address signal ADDW may have the same addressing format. The arrangement will be described later with reference to FIG. 2.

FIG. 2 is a schematic diagram showing operations of the memory controller circuit 120 in FIG. 1 configuring storage spaces of the memory 110 according to some embodiments of the present disclosure. As described above, the memory controller circuit 120 may, according to the memory depth of the memory 110, divide the memory 110 into the storage spaces. For example, if a memory depth of the memory 110 is L, the memory controller circuit 120 may divide the memory depth L by 2 to the power of a predetermined value to determine a number of the storage spaces. The predetermined value may be D, in which D may be a positive integer greater than 0. In other words, the memory controller circuit 120 may accordingly divide the memory 110 into 2^{D} storage spaces M[0] to M[2^{D}-1], in which the storage spaces M[0] to M[2^{D}-1] have the same memory width as each other. For example, if a memory width of the memory 110 is W, in which W is a value greater than 0, the memory controller circuit 120 may keep the memory width of each of the storage spaces M[0] to M[2^{D}-1] as W. Equivalently, the memory 110 may be divided into 2^{D} storage spaces M[0] to M[2^{D}-1] by the configuration of the memory controller circuit 120, and a data capacity of each of the storage spaces M[0] to M[2^{D}-1] is L/2^{D} × W.

Furthermore, as described above, the memory controller circuit 120 may use the storage spaces M[0] to M[2^{D}-1] according to the address signal ADDW and/or the address signal ADDR. Taking the address signal ADDW as an example, least significant bits (LSBs) in the address signal ADDW may indicate a corresponding one of the storage spaces M[0] to M[2^{D}-1]. In some embodiments, the LSBs may be represented as ADDW[(D-1):0], that is, a number of bits of the LSBs ADDW[(D-1):0] is the predetermined value D. For example, if the predetermined value D is 2, the memory 110 will be divided into 4 (that is, 2²) storage spaces. Under this condition, the number of bits of the LSBs ADDW[(D-1):0] may be 2. When the LSBs ADDW[(D-1):0] are 00, the memory controller circuit 120 may accordingly select a first storage space M[0]. When the LSBs ADDW[(D-1):0] are 01, the memory controller circuit 120 may accordingly select a second storage space M[1]. When the LSBs ADDW[(D-1):0] are 10, the memory controller circuit 120 may accordingly select a third storage space M[2]. When the LSBs ADDW[(D-1):0] are 11, the memory controller circuit 120 may accordingly select a fourth storage space M[3]. Thus, a corresponding addressing relationship between the LSBs ADDW[(D-1):0] and the storage spaces M[0] to M[2^{D}-1] may be understood.

On the other hand, remaining bits in the address signal ADDW (which may include a most significant bit) are used to indicate a location corresponding to the remaining bits in a corresponding one of the storage spaces M[0] to M[2^{D}-1]. In some embodiments, the remaining bits may be expressed as ADDW[:D], that is, a starting bit of the remaining bits ADDW[:D] in the address signal ADDW is the (D+1)th bit. For example, if the predetermined value D is 2, a first bit to a Dth bit are the LSBs described above, and the remaining bits are a (D+1)th bit to a last bit in the address signal ADDW. In some embodiments, a number of bits of the remaining bits is determined according to a memory depth (that is, L/2^{D}) of each storage space M[0] to M[2^{D}-1].

With the above configuration, the memory controller circuit 120 may select one storage space, for example, the storage space M[0], from the storage spaces M[0] to M[2^{D}-1] according to the LSBs ADDW[(D-1):0] of the address signal ADDW, and, according to the remaining bits ADDW[:D] of the address signal ADDW, store a corresponding one of the subdata SD[P] in the location corresponding to the remaining bits in the storage space, for example, the first location. For example, if the LSBs ADDW[(D-1):0] are 00 and the remaining bits ADDW[:D] are 0x00000, the LSBs and the remaining bits may be used to indicate the first location in the storage space M[0] that may store the corresponding subdata SD[P]. Similarly, the memory controller circuit 120 may also read corresponding subdata from a corresponding one of the storage spaces M[0] to M[2^{D}-1] according to the remaining bits and the LSBs in the address signal ADDR, and provide the corresponding subdata to a corresponding one of the master devices 101[0] to 101[N-1].

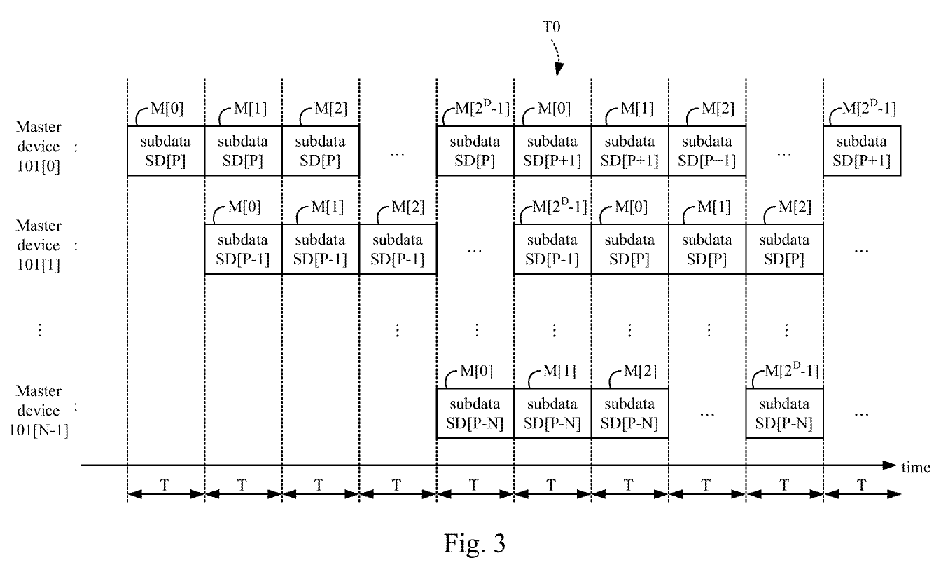

FIG. 3 is a schematic diagram showing operations of the master devices 101[0] to 101[N-1] accessing the memory device 100 according to some embodiments of the present disclosure. As described above, the memory controller circuit 120 may divide the data D[P] into the multiple subdata SD[P], and respectively store the multiple subdata SD[P] in the storage spaces M[0] to M[2^{D}-1] of FIG. 2. Similarly, the memory controller circuit 120 may divide the data D[P-N] into the multiple subdata SD[P-N] and respectively store those subdata SD[P-N] in the storage spaces M[0] to M[2^{D}-1] of FIG. 2. Thus, the memory controller circuit 120 may, in consecutive periods T, sequentially provide the multiple subdata SD[P] to a master device, for example, the master device 101[0], so that the master device 101[0] may obtain the data D[P] according to the multiple subdata SD[P]. For example, after receiving all the subdata SD[P], the master device 101[0] may combine those subdata SD[P] to obtain the data D[P].

In addition, as shown in FIG. 3, the memory controller circuit 120 may provide different subdata to different master devices within the same period T. For example, in a second period T, the memory controller circuit 120 may respectively provide the subdata SD[P] in the storage space M[1] and the subdata SD[P-1] in the storage space M[0] to the master device 101[0] and the master device 101[1]. Similarly, in a subsequent single period T, the memory controller circuit 120 may simultaneously provide the subdata SD[P+1] to SD[P-N] to the master devices 101[0] to 101[N-1]. Therefore, a maximum number of subdata that the memory controller circuit 120 is able to transmit within the same period T is the same as a number of the storage spaces M[0] to M[2^{D}-1] (that is, 2^{D}). If a number of the master devices 101[0] to 101[N-1] is the same as a number of the storage spaces M[0] to M[2^{D}-1] (that is, N equals 2^{D}), the memory controller circuit 120 may, within the same period T (e.g., the period T0), respectively provide the subdata stored in all the storage spaces M[0] to M[2^{D}-1] to the master devices 101[0] to 101[N-1].

In some related approaches, a memory device stores data in a memory according to consecutive physical addresses, and the memory may only be accessed by one device at the same time. When external devices need to simultaneously access the data in the memory, the external devices need to queue to access the memory, resulting in most external devices being in an idle state and reducing overall performance. Compared with the above approaches, in some embodiments of the present disclosure, with the above addressing mechanism, the memory controller circuit 120 may divide the memory 110 into storage spaces, such that the storage spaces may be simultaneously accessed by different devices. As a result, an amount of data that the memory device 100 is able to process within the same period may be increased by 2^{D} times, thereby improving overall system performance.

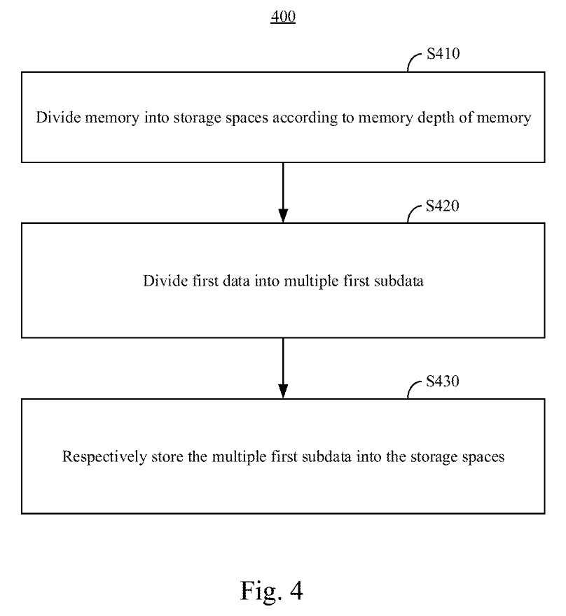

FIG. 4 is a flowchart of a data accessing method 400 according to some embodiments of the present disclosure. In some embodiments, the data accessing method 400 may be executed by the memory controller circuit 120 of FIG. 1, but the present disclosure is not limited thereto.

In operation S410, the memory (e.g., the memory 110 of FIG. 1) is divided into storage spaces (e.g., the storage spaces M[0] to M[2^{D}-1] of FIG. 2) according to a memory depth of the memory. In operation S420, first data (e.g., the data D[P] of FIG. 1) is divided into multiple first subdata (e.g., the multiple subdata SD[P] of FIG. 1, FIG. 2 or FIG. 3). In operation S430, the multiple first subdata are respectively stored into the storage spaces.

Operations related to the data accessing method 400 may be understood with reference to descriptions of the above embodiments and will not be repeated herein. Operations in the data accessing method 400 are merely examples and are not necessarily performed in the order shown in this example. Without departing from operation modes and scope of various embodiments of the present disclosure, related operations in the data accessing method 400 may be appropriately added, replaced, omitted, or performed in a different order. Alternatively, related operations in the above figures may be performed simultaneously or partially simultaneously.

As described above, the memory device and the data accessing method provided in some embodiments of the present disclosure may store data alternately by dividing the memory and using a novel addressing mechanism, so as to increase a number of data that can be processed within a single period, thereby improving overall system performance.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications according to the claims of present disclosure are all consequently viewed as being embraced by the scope of the present disclosure.

What is claimed is:

1. A memory device, comprising:
a memory; and
a memory controller circuit configured to, according to a memory depth of the memory, divide the memory into a plurality of storage spaces, divide first data into a plurality of first subdata, and respectively store the plurality of first subdata into the plurality of storage spaces.

2. The memory device of claim 1, wherein the memory controller circuit is configured to select a first storage space from the plurality of storage spaces according to least significant bits of an address signal, and store a corresponding one of the plurality of first subdata in a location corresponding to a remaining bit of the address signal in the first storage space according to the remaining bit of the address signal.

3. The memory device of claim 2, wherein a number of the storage spaces is 2 to the power of a predetermined value, and a number of bits of the least significant bits is the predetermined value.

4. The memory device of claim 1, wherein the memory controller circuit is further configured to sequentially provide the plurality of first subdata to a master device, so that the master device obtains the first data according to the plurality of first subdata.

5. The memory device of claim 1, wherein the plurality of storage spaces have the same memory width as each other.

6. The memory device of claim 1, wherein a maximum number of subdata that the memory controller circuit is able to transmit within the same period is the same as a number of the plurality of storage spaces.

7. The memory device of claim 1, wherein the memory controller circuit is further configured to respectively store a plurality of second subdata corresponding to second data in the plurality of storage spaces, and respectively provide one of the plurality of first subdata and one of the plurality of second subdata to different master devices within the same period.

8. A data accessing method, performed by a memory controller circuit, the data accessing method comprising:
dividing a memory into a plurality of storage spaces according to a memory depth of the memory;
dividing first data into a plurality of first subdata; and
respectively storing the plurality of first subdata into the plurality of storage spaces.

9. The data accessing method of claim 8, wherein respectively storing the plurality of first subdata into the plurality of storage spaces comprises:
selecting a first storage space from the plurality of storage spaces according to least significant bits of an address signal; and
storing a corresponding one of the plurality of first subdata in a location corresponding to a remaining bit of the address signal in the first storage space according to the remaining bit of the address signal.

10. The data accessing method of claim 9, wherein a number of the storage spaces is 2 to the power of a predetermined value, and a number of bits of the least significant bits is the predetermined value.

11. The data accessing method of claim 8, further comprising:
respectively storing a plurality of second subdata corresponding to second data into the storage spaces; and
respectively providing one of the plurality of first subdata and one of the plurality of second subdata to different master devices within the same period.

12. The data accessing method of claim 8, further comprising:
sequentially providing the plurality of first subdata to a master device, so that the master device obtains the first data according to the plurality of first subdata.

13. The data accessing method of claim 8, wherein the plurality of storage spaces have the same memory width as each other.

14. The data accessing method of claim 8, wherein a maximum number of subdata that the memory controller circuit is able to transmit within the same period is the same as a number of the plurality of storage spaces.
